(19) United States
(12) Patent Application Publication
(10) Pub. No.: US 2025/0173917 A1
(43) Pub. Date: May 29, 2025

(54) VIDEO GENERATION METHOD AND APPARATUS, COMPUTER DEVICE, AND STORAGE MEDIUM

(71) Applicant: Beijing Zitiao Network Technology Co., Ltd., Beijing (CN)

(72) Inventors: Yiyong Li, Beijing (CN); Yanxiang Deng, Beijing (CN); Guibo Pan, Beijing (CN); Yifan Zhu, Beijing (CN)

(21) Appl. No.: 18/929,429

(22) Filed: Oct. 28, 2024

(30) Foreign Application Priority Data
Nov. 29, 2023 (CN) 202311616036.8

(51) Int. Cl. G06T 11/00; G06F 40/20; G06Q 30/0241

(52) U.S. Cl. CPC G06T 11/00; G06F 40/20; G06Q 30/0276; G06T 2211/441

(57) ABSTRACT

The present disclosure provides a video generation method and apparatus, a computer device, and a storage medium. The method includes: obtaining text content to be converted of a book; generating a plot content summary for a plurality of video types based on key plot content in the text content to be converted; and generating a corresponding target video based on the plot content summary for each video type, where the target video includes at least a book promotion video and an episodic video of the book. The embodiments of the present disclosure can implement efficient and accurate book-to-video conversion, and ensure the richness and diversity of book-to-video conversion by converting the same book into target videos in a plurality of video types, thereby improving the vivid visibility of the book transmitted in the form of the video.

### CROSS-REFERENCE TO RELATED APPLICATION

The present application is based on and claims priority to Chinese Patent Application No. 202311616036.8, filed on Nov. 29, 2023, which is incorporated herein by reference in its entirety.

### TECHNICAL FIELD

The present disclosure relates to the field of computer technologies, and in particular, to a video generation method and apparatus, a computer device, and a storage medium.

### BACKGROUND

With the rapid development of artificial intelligence technologies, there is an increasing demand for content creation using artificial intelligence technologies. In the field of video content creation, there is a creation demand for converting book content into video content to improve the visibility and display vividness of the book content. However, currently available book-to-video conversion methods not only require more manual participation, which reduces the production efficiency of book-to-video conversion, but also have low accuracy of content conversion, affecting conversion effects.

### SUMMARY

Embodiments of the present disclosure provide at least a video generation method and apparatus, a computer device, and a storage medium to ensure efficient and accurate book-to-video conversion.

According to a first aspect, an embodiment of the present disclosure provides a video generation method, comprising:
obtaining text content to be converted of a book;
generating a plot content summary for a plurality of video types based on key plot content in the text content to be converted; and
generating a corresponding target video based on the plot content summary for each video type, wherein the target video comprises at least a book promotion video and an episodic video of the book.

According to a second aspect, an embodiment of the present disclosure further provides a video generation apparatus, comprising:
a text obtaining module configured to obtain text content to be converted of a book;
a summary generation module configured to generate a plot content summary for a plurality of video types based on key plot content in the text content to be converted; and
a video generation module configured to generate a corresponding target video based on the plot content summary for each video type, wherein the target video comprises at least a book promotion video and an episodic video of the book.

According to a third aspect, an embodiment of the present disclosure further provides a computer device, comprising: a processor, a memory, and a bus, wherein the memory stores machine-readable instructions executable by the processor; when the computer device is running, the processor communicates with the memory through the bus; and when the machine-readable instructions are executed by the processor, the steps of the video generation method according to the first aspect or any one of possible implementations of the first aspect are performed.

According to a fourth aspect, an embodiment of the present disclosure further provides a non-transitory computer-readable storage medium having a computer program stored thereon, wherein the computer program when executed by a processor causes the processor to perform the steps of the video generation method according to the first aspect or any one of possible implementations of the first aspect.

The video generation method and apparatus, the computer device, and the storage medium provided in the embodiments of the present disclosure first obtain text content to be converted of a book, and generate a plot content summary for a plurality of video types based on key plot content in the text content to be converted, to generate a target video corresponding to each video type. The target video comprises at least a book promotion video and an episodic video of the book. In this way, efficient and accurate book-to-video conversion is implemented, and by converting the same book into target videos in a plurality of video types, the richness and diversity of book-to-video conversion are ensured, thereby improving the vivid visibility of the book transmitted in the form of the video.

To illustrate the objectives, technical solutions, and advantages of the present disclosure more clearly, the following describes the present disclosure in detail with reference to the accompanying drawings and specific embodiments.

### BRIEF DESCRIPTION OF THE DRAWINGS

In order to more clearly describe the technical solutions in the embodiments of the present disclosure, the following briefly introduces the accompanying drawings required for describing the embodiments. The accompanying drawings herein are incorporated in and constitute a part of the specification, illustrate the embodiments conforming to the present disclosure, and are used in conjunction with the specification to explain the technical solutions of the present disclosure. It should be understood that the following accompanying drawings only show some embodiments of the present disclosure, and therefore should not be construed as a limitation on the scope. Persons of ordinary skill in the art can obtain other related drawings based on these accompanying drawings without creative efforts.

FIG. 1 is a flowchart of a video generation method according to an embodiment of the present disclosure;

FIG. 2 is a flowchart of a method for converting a book into a book promotion video according to an embodiment of the present disclosure;

FIG. 3 is a flowchart of a method for converting a book into an episodic video according to an embodiment of the present disclosure;

FIG. 4 is a schematic diagram of a specific process of training to obtain a summary extraction model according to an embodiment of the present disclosure;

FIG. 5 is a schematic diagram of an architecture of a video generation apparatus according to an embodiment of the present disclosure; and

FIG. 6 is a schematic diagram of a structure of a computer device according to an embodiment of the present disclosure.

### DETAILED DESCRIPTION OF EMBODIMENTS

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. It is obvious that the described embodiments are merely some rather than all of the embodiments of the present disclosure. Generally, components of the embodiments of the present disclosure described and shown in the accompanying drawings may be arranged and designed in various different configurations. Therefore, the detailed description of the embodiments of the present disclosure provided in the accompanying drawings is not intended to limit the scope of the present disclosure claimed, but merely represents selected embodiments of the present disclosure. Based on the embodiments of the present disclosure, all other embodiments obtained by a person of ordinary skill in the art without creative efforts shall fall within the scope of protection of the present disclosure.

The inventors have found that although there is a requirement for converting book content into a related video, there is no complete automated book-to-video conversion solution. In addition, the conventional conversion method not only reduces the conversion efficiency due to the need for a large amount of manual participation, but also faces problems such as inaccurate summary extraction and inaccurate content conversion during the conversion process, which affects the effect of the book-to-video conversion.

Based on the above research, the present disclosure provides a video generation method and apparatus, a computer device, and a storage medium. The method first obtains text content to be converted of a book, and generates a plot content summary for a plurality of video types based on key plot content in the text content to be converted, to generate a target video corresponding to each video type. The target video comprises at least a book promotion video and an episodic video of the book. In this way, efficient and accurate book-to-video conversion is implemented, thereby improving the vivid visibility of the book transmitted in the form of the video.

It should be noted that similar reference numerals and letters in the following drawings denote similar items. Therefore, once an item is defined in one drawing, it is not required to be further defined and explained in subsequent drawings.

The term “and/or” in this article is only an association relationship describing, indicating that there may be three relationships, for example, A and/or B, which may indicate: A exists alone, A and B exist at the same time, and B exists alone. In addition, the term “at least one” herein means any one of a variety of or any combination of at least two of a variety of, for example, including at least one of A, B, and C, which may mean including any one or more elements selected from a set consisting of A, B, and C.

For ease of understanding of the present embodiment, a video generation method disclosed in an embodiment of the present disclosure is first described in detail. An execution subject of the video generation method provided in this embodiment of the present disclosure is generally a computer device with a certain computing capability. The computer device includes, for example, a terminal device, a server, or another processing device. The terminal device may be a user equipment (User Equipment, UE), a mobile device, a user terminal, a terminal, a cellular phone, a cordless phone, a personal digital assistant (Personal Digital Assistant, PDA), a handheld device, a computing device, an in-vehicle device, a wearable device, or the like. In some possible implementations, the video generation method may be implemented by a processor calling computer-readable instructions stored in a memory.

The video generation method provided in this embodiment of the present disclosure is described below by using an execution subject as a terminal device as an example.

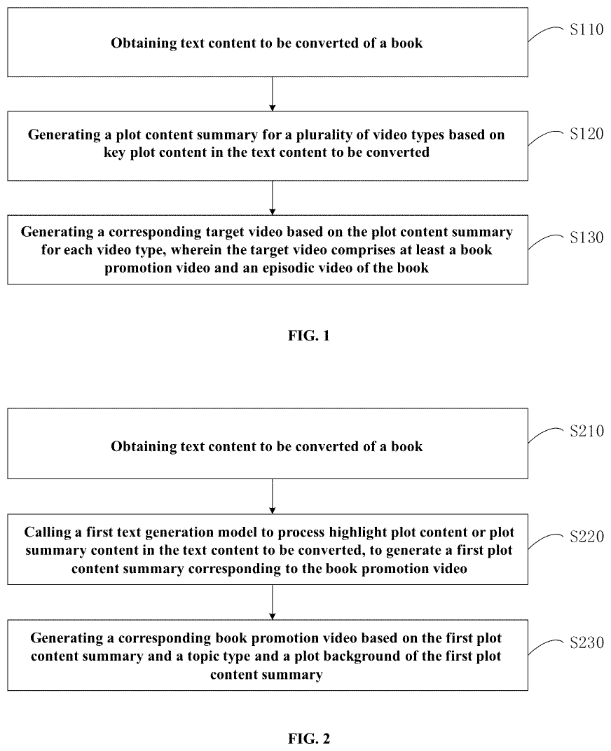

FIG. 1 is a flowchart of a video generation method according to an embodiment of the present disclosure. The method includes the following steps:

S110: Obtain text content to be converted of a book.

The book may be any type of text content with chapters or content divisions, for example, a novel, prose, a script, or a fable. The text content to be converted may be some text content in the book, for example, content of a chapter of a novel, one or more paragraphs of content, some content corresponding to a plot, book review content, or the like.

During specific implementation, considering that requirements of book-to-video conversion are different in different scenarios, for any book, the present disclosure first obtains some or all text content with a video conversion requirement in the book, as the text content to be converted in the present disclosure.

Exemplarily, for the text content to be converted of the book, corresponding text content to be converted may be directly obtained from all text content of the book. Alternatively, corresponding text content to be converted may be obtained from divided text content (for example, content of a chapter or review content of the chapter) after the entire book is first divided into corresponding content.

At S120, a plot content summary for a plurality of video types is generated based on key plot content in the text content to be converted.

Considering that the text to be converted is usually original text content of the book, and the description of the story plot is relatively detailed and complicated. When the book is converted into a video for picture presentation, the video usually needs to display related scene pictures involved in the story plot in a concise and definite way with strong content relevance to the scene.

Therefore, in order to ensure that a book can attract users to watch the book when the book is converted into a video with intuitive and concise pictures, after obtaining the text content to be converted of the book, the present disclosure may first summarize and analyze the text content to be converted of the book, to extract text content for describing a main story plot in the text content to be converted, as the key plot content in the present disclosure.

In addition, in order to ensure the richness of book-to-video conversion, the present disclosure may set a plurality of video types, and set corresponding user viewing requirements for each video type, so that accurate conversion for each video type can be completed.

After the key plot content in the text content to be converted is obtained, the present disclosure may separately perform different text processing and summarization on the key plot content in accordance with the user viewing requirements set for each video type, to generate the plot content summary for each video type.

It should be noted that the plot content summary for each video type may be used to represent a gist and core content to be expressed by the key plot content for the video type. Compared with the key plot content, the plot content summary for each video type is more concise, and is refined content that conforms to video plot development characteristics for each video type after the key plot content is concentrated and summarized, for example, a plot scene change, a role change, role lines, or the like.

At S130, a corresponding target video is generated based on the plot content summary for each video type. The target video comprises at least a book promotion video and an episodic video of the book.

In this embodiment of the present disclosure, for each video type, a plot development process described in the plot content summary for the video type may be analyzed to generate a plurality of plot pictures that can visually express a specific plot development. The pictures may include, but are not limited to, a related scene, a role, stage elements, and the like in the plot development. Then, the plurality of plot pictures may be combined according to a plot development process, to obtain the target video for the video type.

In the same manner as described above, the target video for each video type may be generated by processing the plot content summary for each video type, so that efficient and accurate conversion from the same book to a plurality of videos is implemented.

It should be noted that through analyzing various applicable scenarios of book-to-video conversion, it may be learned that the video obtained after the book is converted is usually used to recommend the book to users in a single-video manner, to ensure efficient book recommendation. Alternatively, the video obtained after the book is converted may also visually introduce a specific story plot expressed in the book to users in an episodic visualization form, to ensure vivid book reading.

Therefore, the target video in different video types in the present disclosure may at least include the book promotion video and the episodic video of the book, to enhance efficient recommendation and vivid reading of book content.

The technical solution provided in the embodiments of the present disclosure first obtains text content to be converted of a book, and generates a plot content summary for a plurality of video types based on key plot content in the text content to be converted, to generate a target video corresponding to each video type. The target video comprises at least a book promotion video and an episodic video of the book. In this way, efficient and accurate book-to-video conversion is implemented, and by converting the same book into target videos in a plurality of video types, the richness and diversity of book-to-video conversion are ensured, thereby improving the vivid visibility of the book transmitted in the form of the video.

As an optional implementation of the present disclosure, considering that a core gist to be expressed for the same book in different video types may be different, for the plot content summary in different video types, different description content in the key plot content may need to be referred to for analysis.

Therefore, in order to ensure the accuracy of book-to-video conversion, for the step of generating the plot content summary for the plurality of video types, specifically, the step may be: generating a first plot content summary corresponding to the book promotion video based on highlight plot content or plot summary content in the text content to be converted; and generating a second plot content summary corresponding to the episodic video based on main thread plot content and an episodic division rule in the text content to be converted.

In other words, the video type in the present disclosure may be at least divided into two types: a book promotion video type and an episodic video type.

It may be understood that for the book promotion video, the main purpose is to attract a large number of users to watch the book through the book promotion video, and the highlight plot or the plot summary of the book may usually express key content of the book. It can be learned that the picture presentation of the highlight plot or the plot summary of the book can enhance the reading attractiveness of the book for users.

Therefore, after obtaining the text content to be converted of the book, the present disclosure may extract corresponding highlight plot content or plot summary content through summarizing and analyzing a specific plot described in the text content to be converted. The highlight plot content may be specific text content in the entire story plot that can highlight the significance of the book and has high attractiveness to users. The plot summary content may be summary content of the development of the entire story plot, and enables users to quickly understand the overall plot of the story development.

Accordingly, in accordance with the user viewing requirements set for the book promotion video, corresponding text processing and summarization may be performed on the highlight plot content or the plot summary content to generate the first plot content summary corresponding to the book promotion video, so that the book can be quickly converted into the corresponding book promotion video.

For the episodic video, the main purpose is to enable a large number of users to fully understand the book by dividing the text content to be converted into a plurality of episodes of content to be played in the episodic video, and the main thread plot of the book may usually express an entire story developing plot process described in the book. It can be learned that the picture presentation of the main thread plot content of the book can enhance the all-round understanding of the book for users.

Therefore, after obtaining the text content to be converted of the book, the present disclosure may extract corresponding main thread plot content through summarizing and analyzing the entire story developing plot described in the text content to be converted. The main thread plot content may be an overall plot development clue that can run through the entire text in accordance with the story development sequence in the entire story plot. The overall plot development clue enables users to accurately and comprehensively understand the complete developing plot of the story. Each episode of video in the episodic video needs to describe a different story plot. Therefore, the present disclosure may preset an episodic division rule according to the episodic requirements to represent a story plot that needs to be mainly expressed in each episode of video.

Accordingly, in accordance with the user viewing requirements set for the episodic video and the preset episodic division rule, corresponding text processing and summarization may be performed on the main thread plot content to generate the second plot content summary corresponding to the episodic video, so that the book can be quickly converted into the corresponding episodic video.

Next, the present disclosure may separately describe in detail two different conversion processes of converting a book into a book promotion video and converting a book into an episodic video.

### 1) Converting a Book Into a Book Promotion Video

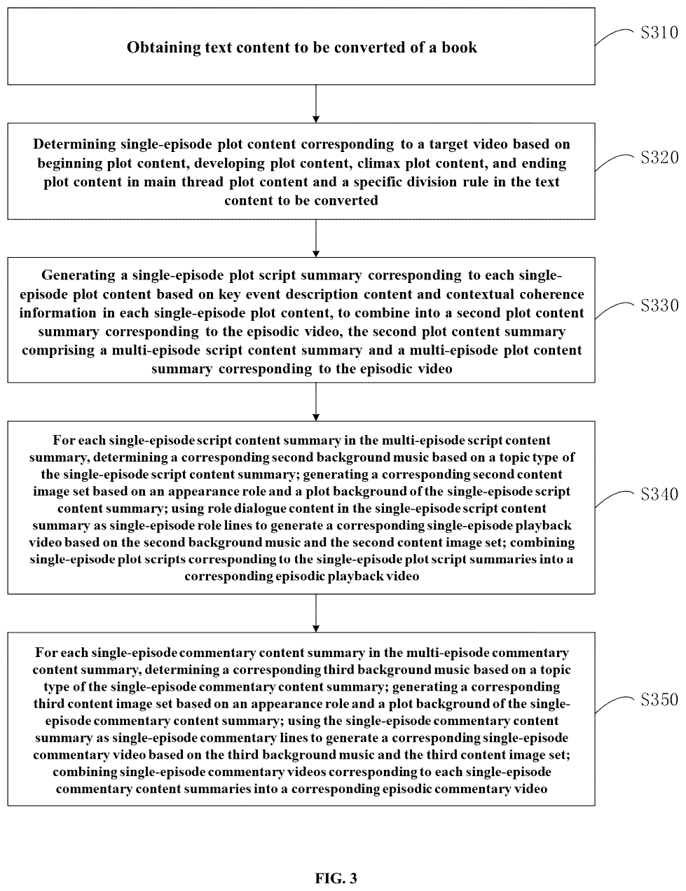

FIG. 2 is a flowchart of a method for converting a book into a book promotion video according to an embodiment of the present disclosure. The method includes the following steps:

S210: Obtain text content to be converted of a book.

S220: Call a first text generation model to process highlight plot content or plot summary content in the text content to be converted, to generate a first plot content summary corresponding to a book promotion video.

The first text model may be a self-developed neural network model dedicated to summary extraction, which can output a text summary conforming to the characteristics of the book promotion video. The characteristics of the book promotion video may include, for example, concise text, definite meaning, strong correlation with a book promotion scene, and the requirement of attracting a large number of users to watch the book. Specifically, the first text generation model may be obtained through training by using a large amount of sample texts and extracting various summary contents conforming to the characteristics of the book promotion video by using reinforcement learning to fine-tune a summary strategy. The sample texts may specifically include various sample text contents, and the sample texts may be generated by using an artificial intelligence model. Generally, the quality of the plot content summary extracted by using the first text generation model is better than the quality of the plot content summary summarized manually.

During specific implementation, after obtaining the text content to be converted of the book, the trained first text generation model may be directly called to first summarize and analyze the text content to be converted, to extract the corresponding highlight plot content or plot summary content. The corresponding highlight plot content or plot summary content is processed by using network parameters conforming to the characteristics of the book promotion video that are trained in the first text generation model, to output the first plot content summary corresponding to the book promotion video.

At S230, a corresponding book promotion video is generated based on the first plot content summary, a topic type of the first plot content summary, and a plot background of the first plot content summary.

In order to ensure the correlation between a picture in the book and a picture in the book promotion video, the present disclosure may first perform corresponding subject matter and scene analysis on the first plot content summary, to determine the topic type and the plot background of the first plot content summary.

The topic type may represent a subject matter of the plot mainly expressed in the first plot content summary. The plot background may represent background items, item placement positions, background atmosphere, and the like required for the plot mainly expressed in the first plot content summary.

Therefore, in accordance with the topic type and the plot background of the first plot content summary, a corresponding text-to-image model may be called to convert the first plot content summary into a plurality of plot pictures conforming to the topic type and the plot background, to form the corresponding book promotion video, thereby implementing efficient and accurate conversion from the book to the book promotion video.

In some implementations, for the book promotion video, the present disclosure may generate the book promotion video by the following steps: determining a corresponding first background music based on the topic type of the first plot content summary; generating a corresponding first content image set based on the plot background of the first plot content summary; and using the first plot content summary as book promotion lines to generate the corresponding book promotion video based on the first background music and the first content image set.

In other words, considering that the book promotion video may include various video elements such as a picture, dubbing, and lines, the present disclosure may analyze the topic type of the first plot content summary to determine music conforming to the subject matter represented by the topic type, as the first background music of the book promotion video.

Moreover, by calling the text-to-image model, the plot background of the first plot content summary may be analyzed to generate a plurality of plot pictures conforming to the plot background, to obtain the first content image set in the present disclosure.

Then, the present disclosure may use the first content image set as video frames in the book promotion video, and fuse the first background music into the book promotion video, to ensure the vividness of the book promotion video. In addition, because the first plot content summary may describe the story highlight plot or the plot summary more comprehensively, the present disclosure may directly use the first plot content summary as the corresponding book promotion lines and fuse the book promotion lines into the book promotion video, to obtain a complete book promotion video. The book promotion video may be composed of background music, pictures, lines, and the like, to ensure the vividness of the book-to-book promotion video conversion.

### 2) Converting a Book Into an Episodic Video

FIG. 3 is a flowchart of a method for converting a book into an episodic video according to an embodiment of the present disclosure. The method includes the following steps:

S310: Obtain text content to be converted of a book.

At S320, single-episode plot content corresponding to an episodic video is determined based on beginning plot content, developing plot content, climax plot content, and ending plot content in main thread plot content of the text content to be converted and an episodic division rule.

Because the complete plot of a story told by the book usually includes four parts: the beginning, the development, the climax, and the ending, when the book is converted into the episodic video, it is required that each episode of video in the episodic video can include the above four aspects, and the preset episodic division rule may represent a plot content part that needs to be specifically described in each episode of video, for example, the first episode and the last episode respectively represent the beginning and the ending of the main thread plot, and the first several episodes of video in the intermediate episodes of video may represent the development and the climax of the main thread plot. In addition, because the climax plot content is usually an attractive and prominent plot, there are more episodes of video for describing the climax plot than episodes of video for describing the developing plot in the intermediate episodes of video. The above is only an example of the episodic division rule, which is not limited in the present disclosure.

During specific implementation, after obtaining the text content to be converted of the book, the present disclosure may first determine the main thread plot content in the text content to be converted. Then, in accordance with the beginning, the development, the climax, and the ending of the story plot, corresponding summarization and analysis may be performed on the main thread plot content to extract the corresponding beginning plot content, the developing plot content, the climax plot content, and the ending plot content.

Furthermore, in accordance with requirements of a video episode number required for the beginning, the development, the climax, and the ending in the preset episodic division rule, corresponding episodic content summarization and analysis may be separately performed on the beginning plot content, the developing plot content, the climax plot content, and the ending plot content to obtain the single-episode plot content corresponding to the episodic video.

At S330, a single-episode plot content summary corresponding to each single-episode plot content is generated based on key event description content and contextual coherence information in each single-episode plot content, to combine into a second plot content summary corresponding to the episodic video. The second plot content summary comprises a multi-episode script content summary and a multi-episode commentary content summary corresponding to the episodic video.

After obtaining each single-episode plot content in the main thread plot content, the present disclosure may perform corresponding key event analysis on each single-episode plot content to obtain the key event description content in each single-episode plot content. The key event may be an event used in the single-episode plot content to represent a decisive role, an important guiding or plot promoting role in a plot development process.

Moreover, by performing correlation analysis on adjacent single-episode plot content of each single-episode plot content in each single-episode plot content, contextual coherence information of each single-episode plot content may be obtained, to ensure the continuity of the episodic plot.

Then, comprehensive analysis is performed on the key event description content and the contextual coherence information in each single-episode plot content, to generate the single-episode plot content summary corresponding to each single-episode plot content. The single-episode plot content summaries can accurately describe the key event and the contextual coherence information in the entire story plot told in the book. Furthermore, the single-episode plot content summaries are combined to obtain the second plot content summary corresponding to the episodic video.

In some implementations, considering that the episodic video is divided into two types: an episodic playback video generated in a script role dialogue form and an episodic commentary video generated in a video commentary form, in accordance with generation requirements of different episodic videos, the second plot content summary corresponding to the episodic video may specifically be generated as the multi-episode script content summary and the multi-episode commentary content summary corresponding to the episodic video.

In this embodiment of the present disclosure, for the step of generating the multi-episode script content summary corresponding to the episodic video, specifically, the step may be: calling a second text generation model to process event background description content and role dialogue content of a key event and the contextual coherence information in each single-episode plot content, to generate a single-episode script content summary corresponding to each single-episode plot content, to combine into a multi-episode script content summary corresponding to the episodic video.

The second text model may be a self-developed neural network model dedicated to summary extraction, which can output a text summary conforming to script role dialogue characteristics of the episodic video. Specifically, the second text generation model and the first text generation model may be obtained through training in a same manner, and different sample texts are labeled with different sample labels in accordance with differences between the book promotion video and the script role dialogue characteristics of the episodic video, to ensure the accuracy of function training of different models.

During specific implementation, after obtaining each single-episode plot content corresponding to the episodic video, the trained second text generation model may be directly called to summarize and analyze each single-episode plot content, to determine corresponding key event-related text content and role dialogue-related text content. In this way, the corresponding event background description content may be extracted in accordance with the key event-related text content, and the corresponding role dialogue content may be extracted in accordance with the role dialogue-related text content.

In addition, the correlation analysis may also be performed on the adjacent single-episode plot content of each single-episode plot content by using the second text generation model, to determine the contextual coherence information of each single-episode plot content.

In this way, the event background description content and the role dialogue content of the key event and the contextual coherence information in each single-episode plot content are comprehensively processed by using network parameters conforming to the script role dialogue characteristics that are trained in the second text generation model, to output the single-episode script content summary corresponding to each single-episode plot content. Then, the single-episode script content summaries are combined to obtain the multi-episode script content summary corresponding to the episodic video.

For the step of generating the multi-episode commentary content summary corresponding to the episodic video, specifically, the step may be: calling a third text generation model to process event description content of the key event and the contextual coherence information in each single-episode plot content, to generate a single-episode commentary content summary corresponding to each single-episode plot content, to combine into a multi-episode commentary content summary corresponding to the episodic video.

The third text model may also be a self-developed neural network model dedicated to summary extraction, which can output a text summary conforming to book commentary characteristics of the episodic video. Specifically, the third text generation model and the first text generation model may be obtained through training in a same manner, and different sample texts are labeled with different sample labels in accordance with differences between the book promotion video and the book commentary characteristics of the episodic video, to ensure the accuracy of function training of different models.

During specific implementation, after obtaining each single-episode plot content corresponding to the episodic video, considering that role dialogue in the book does not need to be analyzed when the video commentary is performed on the book, the present disclosure may directly call the trained third text generation model to summarize and analyze each single-episode plot content, to determine the corresponding key event-related text content, thereby extracting the corresponding event background description content.

In addition, the correlation analysis may also be performed on the adjacent single-episode plot content of each single-episode plot content by using the third text generation model, to determine the contextual coherence information of each single-episode plot content.

In this way, the event background description content and the contextual coherence information of the key event in each single-episode plot content are comprehensively processed by using network parameters conforming to the book video commentary characteristics that are trained in the third text generation model, to output the single-episode commentary content summary corresponding to each single-episode plot content. Then, the single-episode commentary content summaries are combined to obtain the multi-episode commentary content summary corresponding to the episodic video.

At S340, for each single-episode script content summary in the multi-episode script content summary, a corresponding second background music is determined based on a topic type of the single-episode script content summary; a corresponding second content image set is generated based on an appearance role and a plot background of the single-episode script content summary; role dialogue content in the single-episode script content summary is used as single-episode role lines to generate a corresponding single-episode playback video based on the second background music and the second content image set; and single-episode playback videos corresponding to the single-episode script content summaries are combined into a corresponding episodic playback video.

The second plot content summary corresponding to the episodic video may include the multi-episode script content summary and the multi-episode commentary content summary corresponding to the episodic video, and different types of content summaries can generate two types of videos: the episodic playback video and the episodic commentary video.

For conversion from the book to the episodic playback video, after determining the corresponding multi-episode script content summary, the present disclosure considers that the episodic video may include various video elements such as a picture, dubbing, and lines. To ensure the vividness of the episodic playback video, for each single-episode script content summary in the multi-episode script content summary, the present disclosure may analyze the topic type of the single-episode script content summary to determine music conforming to the subject matter represented by the topic type, as the second background music of the single-episode playback video.

In addition, because the dialogue content between roles needs to be played in the episodic playback video, and the roles need to be displayed to users. Therefore, for each single-episode script content summary in the multi-episode script content summary, the present disclosure may first determine the appearance role and the plot background involved in the single-episode script content summary, and call the text-to-image model to generate a plurality of plot pictures conforming to the single-episode role dialogue characteristics and the background according to stage positions of the appearance role, role features, background items in the plot background, and other item features, to obtain the second content image set in the present disclosure.

Then, the present disclosure may use the second content image set as video frames in the single-episode playback video, and fuse the second background music into the single-episode playback video, to ensure the vividness of the episodic video. In addition, the present disclosure may use the role dialogue content in each single-episode script content summary as the corresponding single-episode role lines and fuse the single-episode role lines into the single-episode playback video, to obtain a complete single-episode playback video. Furthermore, the single-episode playback videos corresponding to the single-episode script content summaries may be combined in sequence of the single-episode script content summaries, to obtain the corresponding episodic playback video.

In some implementations, considering that personalities of different appearance roles may be different, roles may have different pronunciations. Therefore, in order to ensure the authenticity and vividness of the episodic playback video, for the step of generating the single-episode playback video, specifically, the step may be: determining a corresponding role dubbing attribute based on the role dialogue content in the single-episode script content summary; and using the role dialogue content in the single-episode script content summary as single-episode role lines to generate the corresponding single-episode playback video based on the second background music, the role dubbing attribute, and the second content image set.

In other words, for each single-episode script content summary, the present disclosure may analyze the role dialogue content corresponding to each appearance role in the single-episode script content summary to determine a personality attribute of each appearance role, thereby determining the suitable role dubbing attribute for each appearance role. The role dubbing attribute may represent various pronunciation characteristics such as pronunciation timbre, pitch, duration, and sound quality of the appearance role.

Then, the present disclosure may use the second content image set as video frames in the single-episode playback video, and fuse the second background music into the single-episode playback video, to ensure the vividness of the episodic video. In addition, the present disclosure may use the role dialogue content in each single-episode script content summary as the corresponding single-episode role lines, and perform pronunciation setting based on the suitable role dubbing attribute for each appearance role, to fuse the single-episode role lines into the single-episode playback video, to obtain a complete single-episode playback video, thereby ensuring the vividness of the episodic playback video.

At S350, for each single-episode commentary content summary in the multi-episode commentary content summary, a corresponding third background music is determined based on a topic type of the single-episode commentary content summary; a corresponding third content image set is generated based on an appearance role and a plot background of the single-episode commentary content summary; the single-episode commentary content summary is used as single-episode commentary lines to generate a corresponding single-episode commentary video based on the third background music and the third content image set; and single-episode commentary videos corresponding to the single-episode commentary content summaries are combined into a corresponding episodic commentary video.

For conversion from the book to the episodic commentary video, after determining the corresponding multi-episode commentary content summary, the present disclosure considers that the episodic video may include various video elements such as a picture, dubbing, and lines. To ensure the vividness of the episodic commentary video, for each single-episode commentary content summary in the multi-episode commentary content summary, the present disclosure may analyze the topic type of the single-episode commentary content summary to determine music conforming to the subject matter represented by the topic type, as the third background music of the single-episode commentary video.

In addition, because the episodic commentary video may need to comment on various events executed by the appearance roles, the roles need to be displayed to users. Therefore, for each single-episode commentary content summary in the multi-episode commentary content summary, the present disclosure may first determine the appearance role and the plot background involved in the single-episode commentary content summary, and call the text-to-image model to generate a plurality of plot pictures conforming to characteristics of the appearance role and the background according to stage positions of the appearance role, role features, background items in the plot background, and other item features, to obtain the third content image set in the present disclosure.

Then, the present disclosure may use the third content image set as video frames in the single-episode commentary video, and fuse the third background music into the single-episode commentary video, to ensure the vividness of the episodic video. In addition, because each single-episode commentary content summary may describe plot content to be expressed by the single-episode video more comprehensively, the present disclosure may use each single-episode commentary content summary as the corresponding single-episode commentary lines and fuse the single-episode commentary lines into the single-episode commentary video, to obtain a complete single-episode commentary video. Furthermore, the single-episode commentary videos corresponding to the single-episode commentary content summaries may be combined in sequence of the single-episode commentary content summaries, to obtain the corresponding episodic commentary video.

It should be noted that S340 and S350 in the embodiments of the present disclosure are steps of generating different types of episodic videos. The present disclosure may perform either S340 or S350, or may perform both S340 and S350. When both S340 and S350 need to be performed, S340 and S350 may be performed sequentially or simultaneously, and there is no execution sequence between S340 and S350.

It should be noted that the first text generation model, the second text generation model, and the third text generation model mentioned in the present disclosure are mainly used to extract content summaries in different types from a text content, for example, the first plot content summary corresponding to the book promotion video and the multi-episode script content summary and the multi-episode commentary content summary corresponding to the episodic video. In other words, the first text generation model, the second text generation model, and the third text generation model may all exist as summary extraction models. Then, for the first text generation model, the second text generation model, and the third text generation model, all of them may be obtained through training in the following manner, except that sample texts input to each model are labeled with different sample labels, and different text generation models with different functions are trained.

In an embodiment, the first text generation model, the second text generation model, and the third text generation model mentioned in the present disclosure may be collectively referred to as a summary extraction model, which is obtained through training according to the following steps:

S1: Obtain a first sample dataset. The first sample dataset includes a plurality of pieces of first sample data, and the first sample data includes a first sample text content and a first sample content summary corresponding to the first sample text content. The first sample data is generated by using an artificial intelligence model.

The first sample text content herein may be text content of any length, and the first summary data is a text summary extracted based on the first sample text content, which can represent a gist and core content of the first sample text content. Compared with the first sample text content, the first summary data is more concise, and is obtained after the first sample text content is concentrated and summarized. Optionally, the first sample content summary may also include some summaries of poor quality. In this way, the first sample dataset may include some positive samples and some negative samples. In other words, the first sample dataset may include a large amount of high-quality first sample data, and may also include some low-quality first sample data.

The first sample content summary may be generated by using an artificial intelligence model, or may be manually generated. The first sample dataset may include a plurality of pieces of first sample data.

Exemplarily, a large amount of first sample text content of different scenarios, different styles, and different types may be generated by using the artificial intelligence model, and the first sample content summary corresponding to each piece of first sample text content is obtained; and then the first sample dataset may be generated based on the first sample text content and the corresponding first sample content summary. After it is determined that model training needs to be performed, the first sample dataset including the large amount of first sample data may be directly obtained.

S2: Use the first sample data to iteratively train a to-be-trained network model, to obtain an initial extraction model.

The to-be-trained network model herein may be a pre-constructed model, which has a function of extracting a content summary corresponding to a text content, but the extraction precision of the model may be poor, and the extraction precision needs to be improved through training. The initial extraction model is a trained network model, which has higher extraction precision than the to-be-trained network model, and the quality of the content summary extracted thereby is higher.

During specific implementation, the first sample text content in the first sample data may be input to the to-be-trained network model to obtain a prediction summary output by the model. Then, a prediction loss may be determined based on the prediction summary and the first sample content summary corresponding to the first sample text content, and the to-be-trained network model is iteratively trained by using the prediction loss, until a training end condition is met, to obtain the pre-trained initial extraction model.

S3: Obtain a second sample dataset, wherein the second sample dataset includes a plurality of pieces of second sample text content.

The second sample dataset herein may include a large amount of second sample data, and the second sample data is the second sample text content. The second sample text content may be text content of any length, may be text content obtained from books of different types and different styles, may be text content generated by using an artificial intelligence model, or may include both the above two types of text content.

During specific implementation, after the initial extraction model is obtained through training, the second sample dataset including only the large amount of second sample text content may be obtained.

S4: Use the second sample text content to perform reinforcement learning training on the initial extraction model in a reinforcement learning manner, to obtain the summary extraction model.

During specific implementation, the reinforcement learning training may be performed on the initial extraction model by using the second sample text content in the second sample dataset in the reinforcement learning manner, so that the initial extraction model learns text features of the second sample text content, thereby obtaining the summary extraction model.

In an embodiment, S3 may be implemented according to the following steps:

S3-1: Input the second sample text content to the initial extraction model to obtain a first predicted text content summary.

The first predicted text content summary model herein is the initial extraction model, that is, a content summary obtained after the second sample text content is subjected to summary extraction.

During specific implementation, each piece of second sample text content may be input to the initial extraction model to obtain a first predicted text content summary corresponding to each piece of second sample text content that is output by the model.

S3-2: Input the first predicted text content summary to a pre-trained reward model to obtain a first reward score.

The reward model herein is a pre-trained neural network model, which can evaluate a content summary and output a reward score of the text summary. The reward score is used to represent the quality of the content summary. For example, the higher the reward score is, the higher the quality of the content summary is, and the more the content summary conforms to the video characteristics. The first reward score is a reward score corresponding to the first predicted text content summary. For example,

During specific implementation, after each first predicted text content summary is obtained, the first predicted text content summary may be input to the reward model to obtain the first reward score corresponding to the first predicted text content summary.

S3-3: Determine a first prediction loss of the initial extraction model based on the first reward score, and iteratively train the initial extraction model by using the first prediction loss, until a training end condition is met, to obtain the summary extraction model.

The training end condition herein may include that the extraction precision of the model reaches a preset precision and/or the number of iterations of the iterative training reaches a preset number of iterations. The first prediction loss is used to represent a deviation between the first predicted text content summary output by the initial extraction model and a standard text content summary conforming to video characteristics and corresponding to the second sample text content. A smaller first prediction loss indicates that the extraction precision of the model is higher, and the quality of the content summary extracted thereby is higher.

During specific implementation, a probability of generating the summary may be determined based on the first predicted text content summary, and the first prediction loss is determined based on the first reward score and the probability. Then, the initial extraction model may be iteratively trained by using the first prediction loss, until the training end condition is met, to obtain the summary extraction model.

In an embodiment, the reward model may be obtained through training according to the following steps:

T1: Obtain a third sample dataset. The third sample dataset includes a plurality of pieces of third sample data, and the third sample data includes a third sample text content and a second sample content summary and a third sample content summary corresponding to the third sample text content. The second sample content summary and the third sample content summary are generated by using the initial extraction model.

The third sample dataset herein may include a plurality of pieces of third sample data, and each piece of third sample data may include one third sample text content and two different sample summaries corresponding to the third sample text content, that is, the second sample content summary and the third sample content summary. The third sample text content may be text content extracted from any book. The second sample content summary and the third sample content summary may both be output by using the initial extraction model. For example, the third sample text content may be input to the initial extraction model twice successively to obtain content summaries output each time by the initial extraction model, and the content summaries output twice are respectively used as the second sample content summary and the third sample content summary corresponding to the third sample text content.

During specific implementation, the third sample dataset may be created in advance, and when it is determined that the reward model needs to be trained, the third sample dataset may be directly obtained.

T2: Use an artificial intelligence model to perform quality evaluation on the second sample content summary and the third sample content summary, to obtain an evaluation result.

The artificial intelligence model herein also has a function of performing content quality evaluation on the content summary. The evaluation result is used to indicate evaluation scores of the second sample content summary and the third sample content summary, and the evaluation scores are used to indicate the quality of the second sample content summary and the third sample content summary. Higher evaluation scores indicate better quality.

During specific implementation, for each third sample text content, the second sample content summary and the third sample content summary corresponding to the third sample text content may be input to the artificial intelligence model to obtain evaluation scores corresponding to the second sample content summary and the third sample content summary, and the evaluation result is determined based on the evaluation scores. In other words, the artificial intelligence model is used to determine, from the second sample content summary and the third sample content summary, one sample summary with relatively good quality and one sample summary with poor quality.

T3: Use the evaluation result and the third sample data to iteratively train a to-be-trained reward model, to obtain a trained reward model.

During specific implementation, after the evaluation result is obtained, the second sample content summary and the third sample content summary may be separately input to the to-be-trained reward model to obtain prediction reward scores output by the reward model. Then, a reward prediction loss of the to-be-trained reward model is determined based on the prediction reward scores and the evaluation result, and the reward prediction loss may be a cross entropy loss. Then, the to-be-trained reward model may be iteratively trained by using the reward prediction loss to obtain the trained reward model.

In an embodiment, T3 may be implemented according to the following steps:

T3-1: Input the third sample text content and the second sample content summary to the to-be-trained reward model to obtain a second reward score corresponding to the second sample content summary.

T3-2: Input the third sample text content and the third sample content summary to the to-be-trained reward model to obtain a third reward score corresponding to the third sample content summary.

The second reward score herein is a reward score output by the to-be-trained reward model for the second sample content summary. The third reward score is a reward score output by the to-be-trained reward model for the third sample content summary: It should be noted that there is no strict execution sequence between T3-1 and T3-2.

During specific implementation, for any third sample data, the third sample text content and the second sample content summary in the third sample data may be input to the to-be-trained reward model together to obtain the second reward score output by the to-be-trained reward model. In addition, the third sample text content and the third sample content summary in the third sample data may be input to the to-be-trained reward model together to obtain the third reward score output by the to-be-trained reward model.

T3-3: Determine a second prediction loss of the to-be-trained reward model based on the second reward score, the third reward score, and the evaluation result.

The evaluation result herein may indicate a relative quality between the quality of the second sample content summary and the quality of the third sample content summary. The second prediction loss is used to represent a deviation between the reward score output by the to-be-trained reward model and an actual score corresponding to the sample summary.

During specific implementation, after the second reward score and the third reward score are obtained, a probability that a reward score corresponding to a sample summary with relatively higher quality in the second sample content summary and the third sample content summary is greater than a reward score corresponding to a sample summary with relatively lower quality may be determined based on the second reward score and the third reward score, a cross entropy loss is determined based on the probability, and the determined cross entropy loss is used as the second prediction loss.

T3-4: Use the second prediction loss to iteratively train the to-be-trained reward model, until a training end condition is met, to obtain the trained reward model.

During specific implementation, after the second prediction loss is obtained, the to-be-trained reward model may be iteratively trained by using the second prediction loss, to obtain the trained reward model after the number of iterations of the iterative training reaches a preset number of iterations and/or the prediction precision reaches a preset precision.

Optionally, after the evaluation scores of the second sample content summaries and the third sample content summaries are obtained, the evaluation scores may be sorted to obtain a sorting result. The sorting result is used to indicate the quality of the second sample content summaries and the third sample content summaries. After the sorting result is obtained, the second sample content summaries and the third sample content summaries may be separately input to the to-be-trained reward model to obtain the prediction reward scores. Then, the second prediction loss is determined based on the prediction reward scores and the sorting result, and the to-be-trained reward model is trained by using the second prediction loss to obtain the trained reward model.

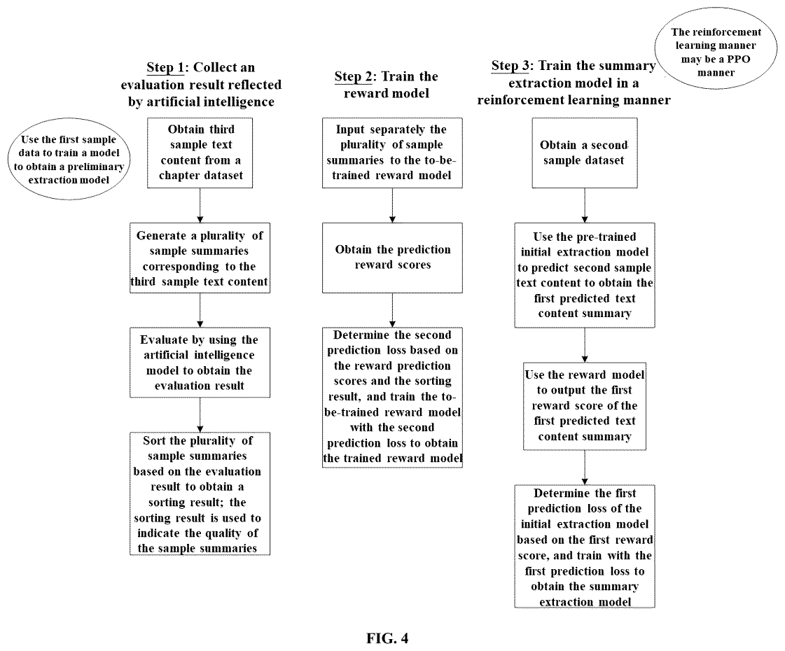

FIG. 4 is a schematic diagram of a specific process of training to obtain the summary extraction model according to an embodiment of the present disclosure. The process may include Step 1 to Step 3. Step 1 is to collect an evaluation result fed back by the artificial intelligence model, and specifically may include obtaining third sample text content from a chapter dataset. Use the pre-trained initial extraction model to generate a plurality of sample summaries (specifically the second sample content summary and the third sample content summary) corresponding to the third sample text content. Evaluate by using the artificial intelligence model to obtain the evaluation result, and sort the plurality of sample summaries based on the evaluation result to obtain a sorting result. The sorting result is used to indicate the quality of the sample summaries. Step 2 is to train the reward model, and specifically may include separately inputting the generated plurality of sample summaries corresponding to each third sample text content to the to-be-trained reward model to obtain the prediction reward scores. Determine the second prediction loss based on the reward prediction scores and the sorting result, and train the to-be-trained reward model by using the second prediction loss to obtain the trained reward model. Step 3 is to train the summary extraction model in a reinforcement learning manner, and the reinforcement learning manner may be, for example, a proximal policy optimization (Proximal Policy Optimization, PPO) manner. Specifically, the step may include obtaining a second sample dataset, and using the pre-trained initial extraction model to predict second sample text content in the second sample dataset to obtain the first predicted text content summary. Use the reward model to output the first reward score of the first predicted text content summary. Determine the first prediction loss of the initial extraction model based on the first reward score, and train by using the first prediction loss to obtain the summary extraction model.

Persons skilled in the art may understand that, in the above method of the specific implementations, the writing sequence of the steps does not mean a strict execution sequence, and does not constitute any limitation on the implementation process. The specific execution sequence of the steps should be determined by functions and possible internal logic of the steps.

Based on the same inventive concept, an embodiment of the present disclosure further provides a video generation apparatus corresponding to the video generation method. Because the apparatus in this embodiment of the present disclosure solves problems in a similar principle to that of the above video generation method in the embodiments of the present disclosure, the implementation of the apparatus may refer to the implementation of the method, and details of the same parts are not described again.

FIG. 5 is a schematic diagram of an architecture of a video generation apparatus 500 according to an embodiment of the present disclosure. The apparatus includes:
a text obtaining module 510, configured to obtain text content to be converted of a book;
a summary generation module 520, configured to generate plot content summaries in a plurality of video types based on key plot content in the text content to be converted; and
a video generation module 530, configured to generate a corresponding target video based on the plot content summary in each video type, where the target video at least includes a book promotion video and an episodic video of the book. In a possible implementation, the summary generation module 520 may include:
a first summary generation unit, configured to generate a first plot content summary corresponding to the book promotion video based on highlight plot content or plot summary content in the text content to be converted; and
a second summary generation unit, configured to generate a second plot content summary corresponding to the episodic video based on main thread plot content in the text content to be converted and an episodic division rule.

In a possible implementation, the first summary generation unit may be specifically configured to:
call a first text generation model to process the highlight plot content or the plot summary content, to generate the first plot content summary corresponding to the book promotion video.

In a possible implementation, the second summary generation unit may include:
an individual episode content determination subunit, configured to determine single-episode plot content corresponding to the episodic video based on beginning plot content, developing plot content, climax plot content, and ending plot content in the main thread plot content and the episodic division rule; and
an individual episode summary generation subunit, configured to generate a single-episode plot content summary corresponding to each single-episode plot content based on key event description content and contextual coherence information in each single-episode plot content, to combine into the second plot content summary corresponding to the episodic video.

In a possible implementation, the individual episode summary generation subunit may be specifically configured to:
call a second text generation model to process event background description content and role dialogue content of a key event and the contextual coherence information in each single-episode plot content, to generate a single-episode script content summary corresponding to each single-episode plot content, to combine into a multi-episode script content summary corresponding to the episodic video; and
call a third text generation model to process event description content of the key event and the contextual coherence information in each single-episode plot content, to generate a single-episode commentary content summary corresponding to each single-episode plot content, to combine into a multi-episode commentary content summary corresponding to the episodic video.

In a possible implementation, the video generation module 530 may include:
a book promotion video generation unit, configured to generate a corresponding book promotion video based on the first plot content summary and a topic type and a plot background of the first plot content summary; and
an episodic video generation unit, configured to generate a corresponding episodic video based on the second plot content summary and a topic type, an appearance role, and a plot background of the second plot content summary. In a possible implementation, the book promotion video generation unit may be specifically configured to:
determine a corresponding first background music based on the topic type of the first plot content summary;
generate a corresponding first content image set based on the plot background of the first plot content summary; and
use the first plot content summary as book promotion lines to generate a corresponding book promotion video based on the first background music and the first content image set.

In a possible implementation, the second plot content summary includes a multi-episode script content summary and a multi-episode commentary content summary corresponding to the episodic video.

In a possible implementation, the episodic video generation unit may be specifically configured to:
for each single-episode script content summary in the multi-episode script content summary, determine a corresponding second background music based on a topic type of the single-episode script content summary;
generate a corresponding second content image set based on an appearance role and a plot background of the single-episode script content summary;
use role dialogue content in the single-episode script content summary as single-episode role lines to generate a corresponding single-episode playback video based on the second background music and the second content image set; and
combine single-episode playback videos corresponding to the single-episode script content summaries into a corresponding episodic playback video.

In a possible implementation, the episodic video generation unit may be specifically configured to:
determine a corresponding role dubbing attribute based on the role dialogue content in the single-episode script content summary; and
use the role dialogue content in the single-episode script content summary as single-episode role lines to generate the corresponding single-episode playback video based on the second background music, the role dubbing attribute, and the second content image set.

In a possible implementation, the episodic video generation unit may be specifically configured to:
for each single-episode commentary content summary in the multi-episode commentary content summary, determine a corresponding third background music based on a topic type of the single-episode commentary content summary;
generate a corresponding third content image set based on an appearance role and a plot background of the single-episode commentary content summary;
use the single-episode commentary content summary as single-episode commentary lines to generate a corresponding single-episode commentary video based on the third background music and the third content image set; and
combine single-episode commentary videos corresponding to the single-episode commentary content summaries into a corresponding episodic commentary video.

Descriptions of a processing flow of each module in the apparatus and an interaction flow between the modules may refer to relevant descriptions in the above method embodiments, and details are not described herein again.

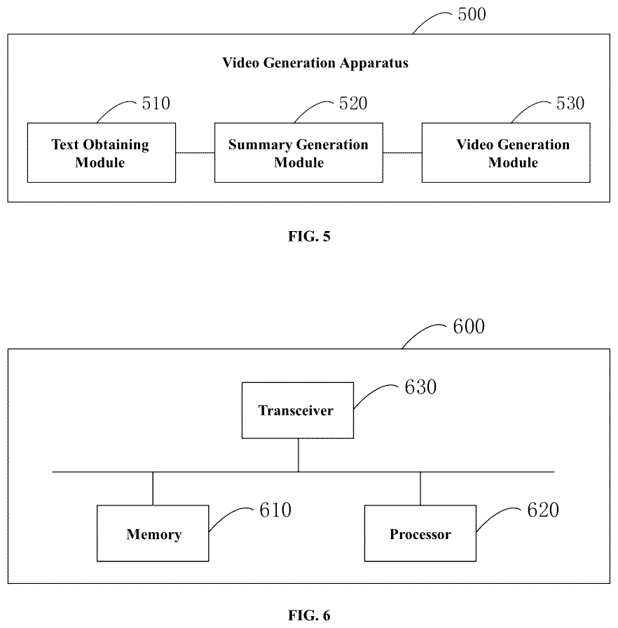

Based on the same technical concept, an embodiment of the present disclosure further provides a computer device. As shown in FIG. 6, a schematic diagram of a structure of a computer device according to an embodiment of the present disclosure includes:
a processor 601, a memory 602, and a bus 603. The memory 602 stores machine-readable instructions executable by the processor 601. The processor 601 is configured to execute the machine-readable instructions stored in the memory 602. When the machine-readable instructions are executed by the processor 601, the processor 601 executes the following steps: S110: Obtain text content to be converted of a book; S120: Generate plot content summaries in a plurality of video types based on key plot content in the text content to be converted; and S130: Generate a corresponding target video based on the plot content summary in each video type, where the target video at least includes a book promotion video and an episodic video of the book.

The memory 602 includes an internal memory 6021 and an external memory 6022. The internal memory 6021 is also referred to as an internal storage, and is configured to temporarily store operation data in the processor 601 and data exchanged with the hard disk and other external memories 6022. The processor 601 exchanges data with the external memory 6022 through the internal memory 6021. When the computer device is running, the processor 601 communicates with the memory 602 through the bus 603, so that the processor 601 executes the execution instructions mentioned in the above method embodiments.

An embodiment of the present disclosure further provides a computer-readable storage medium. A computer program is stored on the computer-readable storage medium, and when the computer program is run by a processor, the steps of the video generation method described in the above method embodiments are executed. The storage medium may be a volatile or non-volatile computer-readable storage medium.

An embodiment of the present disclosure further provides a computer program product. The computer program product carries program code, and instructions included in the program code may be used to execute the steps of the video generation method described in the above method embodiments. For details, refer to the above method embodiments, which are not described herein again.

The computer program product may be specifically implemented through hardware, software, or a combination thereof. In an optional embodiment, the computer program product is specifically implemented as a computer storage medium. In another optional embodiment, the computer program product is specifically implemented as a software product, for example, a software development kit (Software Development Kit, SDK), and the like.

Persons skilled in the art may clearly understand that, for the convenience and brevity of description, for the specific working process of the system and the apparatus described above, reference may be made to corresponding processes in the foregoing method embodiments, which are not described herein again. In several embodiments provided in the present disclosure, it should be understood that the disclosed system, apparatus, and method may be implemented in other manners. The apparatus embodiments described above are merely illustrative. For example, the division of the units is merely a logical function division, and there may be another division manner in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and parts displayed as units may or may not be physical units, and may be located in one position, or may be distributed on a plurality of network units. Some or all of the units may be selected according to actual needs to achieve the objectives of the solutions of the embodiments.

In addition, all the functional units in the various embodiments of the present disclosure may be integrated into one processing unit, or each unit may exist alone physically, or two or more units may be integrated into one unit.

If the functions are implemented in the form of software functional units and sold or used as independent products, the functions may be stored in a non-volatile computer-readable storage medium executable by a processor. Based on such an understanding, the technical solutions of the present disclosure are essentially, or the part contributing to the existing technology, or the part of the technical solutions may be embodied in the form of a software product, and the computer software product is stored in a storage medium, including several instructions for enabling a computer device (which may be a personal computer, a server, or a network device) to execute all or some of the steps of the methods described in the embodiments of the present disclosure. The foregoing storage medium includes: various media that can store program codes, such as a universal serial bus (USB) flash drive, a mobile hard disk, a read-only memory (ROM), a random access memory (RAM), a magnetic disk, or an optical disc.

Finally, it should be noted that the foregoing embodiments are merely specific implementations of the present disclosure, and are used for illustrating the technical solutions of the present disclosure, rather than limiting the present disclosure, and the scope of protection of the present disclosure is not limited thereto. Although the present disclosure is described in detail with reference to the foregoing embodiments, persons of ordinary skill in the art should understand that any person skilled in the art can still modify the technical solutions described in the foregoing embodiments or can easily conceive of changes to the technical solutions, or equivalent replacements may be made to some technical features; however, these modifications, changes, or replacements do not cause the essence of the corresponding technical solutions to depart from the spirit and scope of the technical solutions of the embodiments of the present disclosure, and all should fall within the scope of protection of the present disclosure. Therefore, the scope of protection of the present disclosure shall be subject to the scope of protection of the claims.

1. A video generation method, comprising:
obtaining text content to be converted of a book;
generating a plot content summary for a plurality of video types based on key plot content in the text content to be converted; and
generating a corresponding target video based on the plot content summary for each video type, wherein the target video comprises at least a book promotion video and an episodic video of the book.

2. The method according to claim 1, wherein the generating a plot content summary for a plurality of video types based on key plot content in the text content to be converted comprises:
generating a first plot content summary corresponding to the book promotion video based on highlight plot content or plot summary content in the text content to be converted; and
generating a second plot content summary corresponding to the episodic video based on main thread plot content and an episodic division rule in the text content to be converted.

3. The method according to claim 2, wherein the generating a first plot content summary corresponding to the book promotion video based on highlight plot content or plot summary content in the text content to be converted comprises:
calling a first text generation model to process the highlight plot content or the plot summary content, to generate the first plot content summary corresponding to the book promotion video.

4. The method according to claim 2, wherein the generating a second plot content summary corresponding to the episodic video based on main thread plot content and an episodic division rule in the text content to be converted comprises:
determining single-episode plot content corresponding to the episodic video based on beginning plot content, developing plot content, climax plot content, and ending plot content in the main thread plot content and the episodic division rule; and
generating a single-episode plot content summary corresponding to each single-episode plot content based on key event description content and contextual coherence information in each single-episode plot content, to combine into the second plot content summary corresponding to the episodic video.

5. The method according to claim 4, wherein the generating a single-episode plot content summary corresponding to each single-episode plot content based on key event description content and contextual coherence information in each single-episode plot content, to combine into the second plot content summary corresponding to the episodic video comprises:
calling a second text generation model to process event background description content and role dialogue content of a key event and the contextual coherence information in each single-episode plot content, to generate a single-episode script content summary corresponding to each single-episode plot content, to combine into a multi-episode script content summary corresponding to the episodic video; and
calling a third text generation model to process event description content of the key event and the contextual coherence information in each single-episode plot content, to generate a single-episode commentary content summary corresponding to each single-episode plot content, to combine into a multi-episode commentary content summary corresponding to the episodic video.

6. The method according to claim 2, wherein the generating a corresponding target video based on the plot content summary for each video type comprises:
generating a corresponding book promotion video based on the first plot content summary; a topic type of the first plot content summary; and a plot background of the first plot content summary; and
generating a corresponding episodic video based on the second plot content summary, a topic type of the second plot content summary; and a plot background and an appearance role of the second plot content summary.

7. The method according to claim 6, wherein the generating a corresponding book promotion video based on the first plot content summary, a topic type of the first plot content summary, and a plot background of the first plot content summary comprises:
determining a corresponding first background music based on the topic type of the first plot content summary;
generating a corresponding first content image set based on the plot background of the first plot content summary; and
using the first plot content summary as book promotion lines to generate the corresponding book promotion video based on the first background music and the first content image set.

8. The method according to claim 6, wherein the second plot content summary comprises a multi-episode script content summary and a multi-episode commentary content summary corresponding to the episodic video.

9. The method according to claim 8, wherein the generating a corresponding episodic video based on the second plot content summary, a topic type of the second plot content summary, and a plot background and an appearance role of the second plot content summary comprises:
for each single-episode script content summary in the multi-episode script content summary, determining a corresponding second background music based on a topic type of the single-episode script content summary;
generating a corresponding second content image set based on an appearance role and a plot background of the single-episode script content summary;
using role dialogue content in the single-episode script content summary as single-episode role lines to generate a corresponding single-episode playback video based on the second background music and the second content image set; and
combining single-episode playback videos corresponding to each single-episode script content summaries into a corresponding episodic playback video.

10. The method according to claim 9, wherein the using role dialogue content in the single-episode script content summary as single-episode role lines to generate a corresponding single-episode playback video based on the second background music and the second content image set comprises:
determining a corresponding role dubbing attribute based on the role dialogue content in the single-episode script content summary; and
using the role dialogue content in the single-episode script content summary as single-episode role lines to generate the corresponding single-episode playback video based on the second background music, the role dubbing attribute, and the second content image set.

11. The method according to claim 8, wherein the generating a corresponding episodic video based on the second plot content summary; a topic type of the second plot content summary, and a plot background and an appearance role of the second plot content summary further comprises:
for each single-episode commentary content summary in the multi-episode commentary content summary, determining a corresponding third background music based on a topic type of the single-episode commentary content summary;
generating a corresponding third content image set based on an appearance role and a plot background of the single-episode commentary content summary;
using the single-episode commentary content summary as single-episode commentary lines to generate a corresponding single-episode commentary video based on the third background music and the third content image set; and
combining single-episode commentary videos corresponding to each single-episode commentary content summaries into a corresponding episodic commentary video.

12. A computer device, comprising: a processor, a memory, and a bus, wherein the memory stores machine-readable instructions executable by the processor: when the computer device is running, the processor communicates with the memory through the bus; and the machine-readable instructions when executed by the processor cause the processor to perform the steps of the video generation method, comprising:
obtaining text content to be converted of a book;
generating a plot content summary for a plurality of video types based on key plot content in the text content to be converted; and
generating a corresponding target video based on the plot content summary for each video type, wherein the target video comprises at least a book promotion video and an episodic video of the book.

13. The computer device according to claim 12, wherein the generating a plot content summary for a plurality of video types based on key plot content in the text content to be converted comprises:
generating a first plot content summary corresponding to the book promotion video based on highlight plot content or plot summary content in the text content to be converted; and
generating a second plot content summary corresponding to the episodic video based on main thread plot content and an episodic division rule in the text content to be converted.

14. The computer device according to claim 13, wherein the generating a first plot content summary corresponding to the book promotion video based on highlight plot content or plot summary content in the text content to be converted comprises:
calling a first text generation model to process the highlight plot content or the plot summary content, to generate the first plot content summary corresponding to the book promotion video.

15. The computer device according to claim 13, wherein the generating a second plot content summary corresponding to the episodic video based on main thread plot content and an episodic division rule in the text content to be converted comprises:
determining single-episode plot content corresponding to the episodic video based on beginning plot content, developing plot content, climax plot content, and ending plot content in the main thread plot content and the episodic division rule; and
generating a single-episode plot content summary corresponding to each single-episode plot content based on key event description content and contextual coherence information in each single-episode plot content, to combine into the second plot content summary corresponding to the episodic video.

16. The computer device according to claim 15, wherein the generating a single-episode plot content summary corresponding to each single-episode plot content based on key event description content and contextual coherence information in each single-episode plot content, to combine into the second plot content summary corresponding to the episodic video comprises:
calling a second text generation model to process event background description content and role dialogue content of a key event and the contextual coherence information in each single-episode plot content, to generate a single-episode script content summary corresponding to each single-episode plot content, to combine into a multi-episode script content summary corresponding to the episodic video; and
calling a third text generation model to process event description content of the key event and the contextual coherence information in each single-episode plot content, to generate a single-episode commentary content summary corresponding to each single-episode plot content, to combine into a multi-episode commentary content summary corresponding to the episodic video.

17. A non-transitory computer-readable storage medium having a computer program stored thereon, wherein the computer program when executed by a processor causes the processor to perform the steps of the video generation method, comprising:
obtaining text content to be converted of a book;
generating a plot content summary for a plurality of video types based on key plot content in the text content to be converted; and
generating a corresponding target video based on the plot content summary for each video type, wherein the target video comprises at least a book promotion video and an episodic video of the book.

18. The non-transitory computer-readable storage medium according to claim 17, wherein the generating a plot content summary for a plurality of video types based on key plot content in the text content to be converted comprises:
generating a first plot content summary corresponding to the book promotion video based on highlight plot content or plot summary content in the text content to be converted; and
generating a second plot content summary corresponding to the episodic video based on main thread plot content and an episodic division rule in the text content to be converted.

19. The non-transitory computer-readable storage medium according to claim 18, wherein the generating a first plot content summary corresponding to the book promotion video based on highlight plot content or plot summary content in the text content to be converted comprises:
calling a first text generation model to process the highlight plot content or the plot summary content, to generate the first plot content summary corresponding to the book promotion video.

20. The non-transitory computer-readable storage medium according to claim 18, wherein the generating a second plot content summary corresponding to the episodic video based on main thread plot content and an episodic division rule in the text content to be converted comprises:
determining single-episode plot content corresponding to the episodic video based on beginning plot content, developing plot content, climax plot content, and ending plot content in the main thread plot content and the episodic division rule; and
generating a single-episode plot content summary corresponding to each single-episode plot content based on key event description content and contextual coherence information in each single-episode plot content, to combine into the second plot content summary corresponding to the episodic video.
